(19) United States
(12) Patent Application Publication
(10) Pub. No.: US 2006/0074932 A1
(43) Pub. Date: Apr. 6, 2006

(54) Systems and methods for recommendation of personal network

(75) Inventors: Bryant Fong, Kirkland, WA (US); James Coryell Hilke, Redmond, WA (US); Venkatesh Veeraraghavan, Seattle, WA (US); Pawan Deshpande, Andover, MA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/955,471

(22) Filed: Sep. 30, 2004

(51) Int. Cl. G06F 17/30

(52) U.S. Cl. 707/100

(57) ABSTRACT

Systems and methods for automatically recommending a personal network. The systems can include a review module programmed to review communication information. The systems can also include a recommend module in data communication with the review module, the recommend module being programmed to identify one or more contacts from the communication information to be included in a personal network. The recommend module can use a significance function to weight the communication information and rank the contacts identified in the communication information.

### TECHNICAL FIELD

Embodiments of the present invention relates to systems and methods for identifying and recommending a personal network.

### BACKGROUND

An individual uses his or her network of family, friends, and acquaintances when the individual is faced with a problem and needs help solving the problem. For example, in the business setting, an individual typically looks to co-workers with which the individual is acquainted for assistance with problems associated with his or her job. This is especially true in a large corporate setting, where a worker may not personally know all of his or her co-workers. This sub-set of co-workers that individual works with directly and knows personally can be thought of as the individual's “personal network.”

When the individual needs assistance with a problem and cannot identify someone in his or her personal network that can help solve the problem, the individual can look for help outside his or her network. To do this, the individual can contact a member of his or her personal network and ask for a referral to someone in that member's personal network that may be able to solve the problem.

However, it can be time consuming and difficult for an individual to think of all of the people with whom the individual works. Therefore, it can be prohibitive for the individual to identify the individual's personal network of contacts.

In addition, the individual may need assistance with solving a computer problem, but may not personally know anyone in the company's information technology (IT) department that can help solve the computer problem. However, the individual can contact one or more members of the individual's personal network to see anyone has a personal contact in the IT department to which the member can refer the individual. If the individual is successful in locating a member of the individual's personal network that can refer the individual to a person in the IT department, the individual can contact the person in the IT department and reference the member's name to begin to establish a working relationship with the IT person.

The individual can therefore expand the number of people in his or her personal network by relying on the personal networks of others. However, there is no efficient way for the individual to identify which, if any, of the individual's contacts may have a desired contact in their personal network without communicating directly with each contact. For example, if the individual described above is looking for a member of the IT department, the individual may have no idea which, if any, of the contacts in his or her personal network might have a personal contact in the IT department. Further, it can be time consuming to conduct such a search.

It is therefore desirable to provide systems and methods that can automatically review an individual's communication information and identify or recommend a personal network.

### SUMMARY

Embodiments of the present invention relates to systems and methods for identifying and recommending a personal network.

One aspect of the invention relates to a computing system for automatically recommending a personal network. The computing system includes a review module programmed to review communication information, and a recommend module in data communication with the review module, the recommend module being programmed to identify one or more contacts from the communication information and to recommend the contacts to a user for inclusion in a personal network. The computing system also includes a builder module in data communication with the recommend module, the builder module being programmed to build the personal network based on specific contacts selected by the user from the contacts identified by the recommend module.

Another aspect of the invention relates to a method for automatically recommending a personal network, the method including: reviewing communication information stored on one or more computing systems; identifying one or more contacts from the communication information to be included in a personal network; displaying the contacts to a user; and allowing the user to select specific contacts for inclusion in the personal network.

Yet another aspect of the invention relates to a method for building a personal network, including: retrieving communication information; identifying one or more contacts in the communication information; verifying whether each contact is a member of a relevant group; and recommending one or more of the contacts that are members of the relevant group to be included in a personal network.

Another aspect of the invention relates to a computer-readable medium having computer-executable instructions for performing steps including: retrieving communication information; identifying one or more contacts in the communication information; verifying whether each contact is a member of a relevant group; and recommending one or more of the contacts that are members of the relevant group to be included in a personal network.

### BRIEF DESCRIPTION OF THE DRAWINGS

Reference will now be made to the accompanying drawings, which are not necessarily drawn to scale, and wherein:

FIG. 1 illustrates an example general purpose computing system according to one embodiment of the present invention;

FIG. 2 illustrates a computing environment including a computing system and server according to one embodiment of the present invention;

FIG. 3 illustrates another computing environment including a computing system and server according to one embodiment of the present invention;

FIG. 4 illustrates an example method for identifying and recommending a personal network according to one embodiment of the present invention;

FIG. 5 illustrates another example method for identifying and recommending a personal network according to one embodiment of the present invention;

FIG. 6 illustrates an example method for analyzing communication information according to one embodiment of the present invention;

FIG. 7 illustrates an example representation of communication information according to one embodiment of the present invention; and

FIG. 8 illustrates an example profile according to one embodiment of the present invention.

### DETAILED DESCRIPTION

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the present invention relates to systems and methods for identifying and recommending a personal network. For example, embodiments of the present invention relate to systems and methods that automatically review communication information such as, for example, electronic mail, instant messaging contacts, meetings, and distribution lists. Based on this review, the example systems and methods identify one or more contacts that can be included in a personal network.

An individual can use his or her personal network to identify contacts that can help the individual solve a particular problem. In addition, in some embodiments, the personal network can be included as part of a profile for the individual. The individual can access profiles of others in his or her personal network to review their personal networks to identify contacts that may be able to assist the individual in solving a problem.

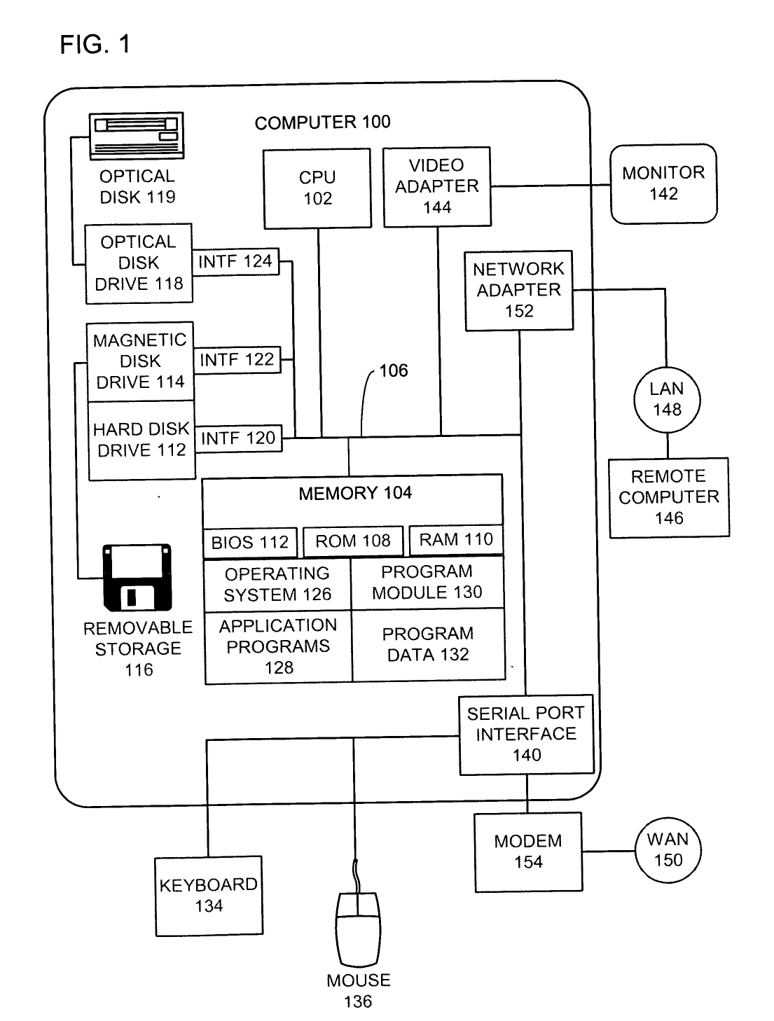

Referring now to FIG. 1, an example computer system 100 is illustrated. The computer system 100 illustrated in FIG. 1 can take a variety of forms such as, for example, a desktop computer, a laptop computer, and a hand-held computer. In addition, although computer system 100 is illustrated, the systems and methods disclosed herein can be implemented in various alternative computer systems as well.

The system 100 includes a processor unit 102, a system memory 104, and a system bus 106 that couples various system components including the system memory 104 to the processor unit 102. The system bus 106 can be any of several types of bus structures including a memory bus, a peripheral bus and a local bus using any of a variety of bus architectures. The system memory includes read only memory (ROM) 108 and random access memory (RAM) 110. A basic input/output system 112 (BIOS), which contains basic routines that help transfer information between elements within the computer system 100, is stored in ROM 108.

The computer system 100 further includes a hard disk drive 112 for reading from and writing to a hard disk, a magnetic disk drive 114 for reading from or writing to a removable magnetic disk 116, and an optical disk drive 118 for reading from or writing to a removable optical disk 119 such as a CD ROM, DVD, or other optical media. The hard disk drive 112, magnetic disk drive 114, and optical disk drive 118 are connected to the system bus 106 by a hard disk drive interface 120, a magnetic disk drive interface 122, and an optical drive interface 124, respectively. The drives and their associated computer-readable media provide nonvolatile storage of computer readable instructions, data structures, programs, and other data for the computer system 100.

Although the example environment described herein can employ a hard disk 112, a removable magnetic disk 116, and a removable optical disk 119, other types of computer-readable media capable of storing data can be used in the example system 100. Examples of these other types of computer-readable mediums that can be used in the example operating environment include magnetic cassettes, flash memory cards, digital video disks, Bernoulli cartridges, random access memories (RAMs), and read only memories (ROMs).

A number of program modules can be stored on the hard disk 112, magnetic disk 116, optical disk 119, ROM 108, or RAM 110, including an operating system 126, one or more application programs 128, other program modules 130, and program data 132.

A user may enter commands and information into the computer system 100 through input devices such as, for example, a keyboard 134, mouse 136, or other pointing device. Examples of other input devices include a toolbar, menu, touch screen, microphone, joystick, game pad, pen, satellite dish, and scanner. These and other input devices are often connected to the processing unit 102 through a serial port interface 140 that is coupled to the system bus 106. Nevertheless, these input devices also may be connected by other interfaces, such as a parallel port, game port, or a universal serial bus (USB). An LCD display 142 or other type of display device is also connected to the system bus 106 via an interface, such as a video adapter 144. In addition to the display 142, computer systems can typically include other peripheral output devices (not shown), such as speakers and printers.

The computer system 100 may operate in a networked environment using logical connections to one or more remote computers, such as a remote computer 146. The remote computer 146 may be a computer system, a server, a router, a network PC, a peer device or other common network node, and typically includes many or all of the elements described above relative to the computer system 100. The network connections include a local area network (LAN) 148 and a wide area network (WAN) 150. Such networking environments are commonplace in offices, enterprise-wide computer networks, intranets, and the Internet.

When used in a LAN networking environment, the computer system 100 is connected to the local network 148 through a network interface or adapter 152. When used in a WAN networking environment, the computer system 100 typically includes a modem 154 or other means for establishing communications over the wide area network 150, such as the Internet. The modem 154, which can be internal or external, is connected to the system bus 106 via the serial port interface 140. In a networked environment, program modules depicted relative to the computer system 100, or portions thereof, may be stored in the remote memory storage device. It will be appreciated that the network connections shown are examples and other means of establishing a communications link between the computers may be used.

The embodiments described herein can be implemented as logical operations in a computing system. The logical operations can be implemented (1) as a sequence of computer implemented steps or program modules running on a computer system and (2) as interconnected logic or hardware modules running within the computing system. This implementation is a matter of choice dependent on the performance requirements of the specific computing system. Accordingly, the logical operations making up the embodiments described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto. This software, firmware, or similar sequence of computer instructions may be encoded and stored upon computer readable storage medium and may also be encoded within a carrier-wave signal for transmission between computing devices.

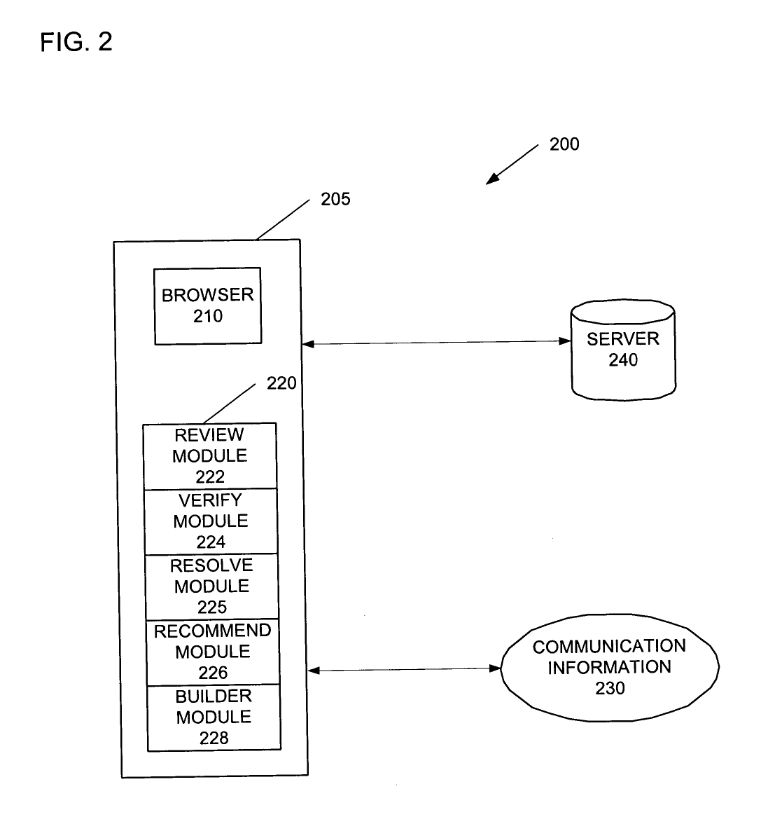

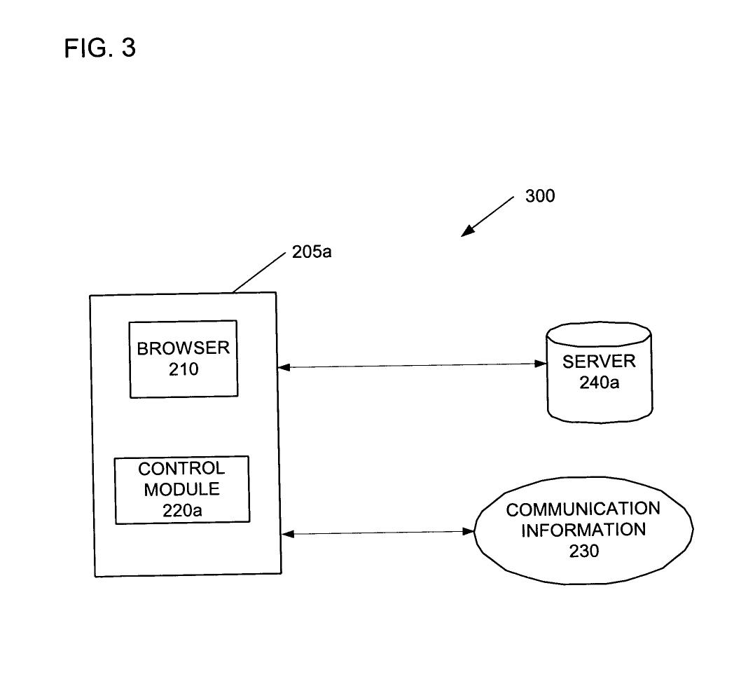

Referring now to FIGS. 2 and 3, example systems for identifying and recommending a personal network are shown. Generally, such systems retrieve communication information such as, for example, one or more of electronic mail, instant messaging contacts, meetings, and distribution lists. The systems can analyze the communication information and identify one or more contacts that can be included in a personal network. In the illustrated embodiments, the systems also verify that the contacts identified in the communication information are members of a relevant group (e.g., have a profile in an organization's directory), as described further below.

Referring now to FIG. 2, an example system 200 is shown. System 200 comprises computer system 205 including browser 210 and control module 220. System 200 also includes communication information 230 and a server 220 in data communication with computer system 205.

System 205 can be configured in a manner similar to that of computer system 100 described above. Browser 210 is a web browser such as, for example, Microsoft(& Internet Explorer. Browser 210 can activate control module 220. In the example embodiment, control module 220 is an ActiveX control including a review module 222, a verify module 224, a resolve module 225, a recommend module 226, and a builder module 228.

Communication information 230 can be, for example, electronic mail, instant messaging contacts, meetings, distribution lists, and/or group memberships. In one example embodiment, communication information 230 is an individual's messaging information stored on a Microsoft® Exchange Server. In other embodiments, communication information 230 can be included in a personal information store (pst) file from Microsoft® Outlook®.

Server 240 is a collaboration network server that includes profile information for the members of an organization. In one example embodiment, server 240 is a Microsoft(& SharePoint® Portal Server.

System 200 can be used as follows. Browser 210 invokes control module 220 on computer system 205. Retrieve module 222 of control module 220 queries communication information 230 and identifies one or more contacts from the communication information using one or more of the methods described below. The identified contacts are then verified and resolved by the verify module 224 and the resolve module 225. Specifically, the verify module 224 and the resolve module 225 communicate with server 240 to verify that each contact is a member of the organization (e.g., has a profile in the organization's contact directory) and to resolve each contact's full contact information, as described further below.

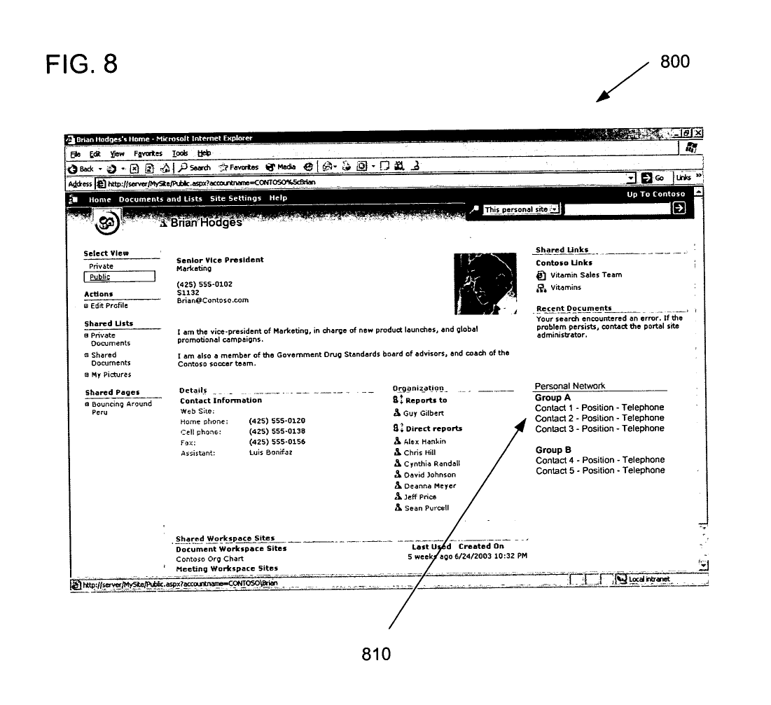

Recommend module 226 then ranks and groups the verified/resolved contacts and presents the results to the user so that the user can select which contacts to include as part of the user's personal network. Finally, builder module 228 builds the personal network of the contacts selected by the user and includes the personal network as part of the user's profile stored on the server 240, as described below and shown in FIG. 8.

In one embodiment, browser 210 invokes control module 220 when the user selects a service that allows the user to build his or her personal network. In another embodiment, the control module 220 is invoked automatically as the browser 210 reaches a given web page (e.g., the user's profile page such as that illustrated in FIG. 8).

In yet another embodiment, the control module 220 is invoked periodically so that the user's personal network can be updated at regular intervals. For example, control module 220 can be configured to periodically analyze a user's communication information and recommend new contacts for inclusion in the user's personal network. In example embodiments, the control module 220 can be invoked at intervals ranging from once per day, once per week, once per month, and once every other month. In other embodiments, the control module 220 can be invoked after a specific amount of new communication information has been generated by a user, or when a ranking of a specific contact reaches a threshold such that recommendation of the specific contact for inclusion in the personal network is desirable.

Referring now to FIG. 3, another example system 300 is shown. System 300 is similar to system 200 described above. However, computer system 205a of system 300 includes control module 220a that queries communication information 230 and forwards the contacts identified in the communication information 230 to server 240a. Server 240a performs the analysis of the contacts, including verification, resolution, ranking, and grouping of the contacts. Server 240a then presents the ranked and grouped contacts to the user in browser 210 to allow the user to select the user's personal network.

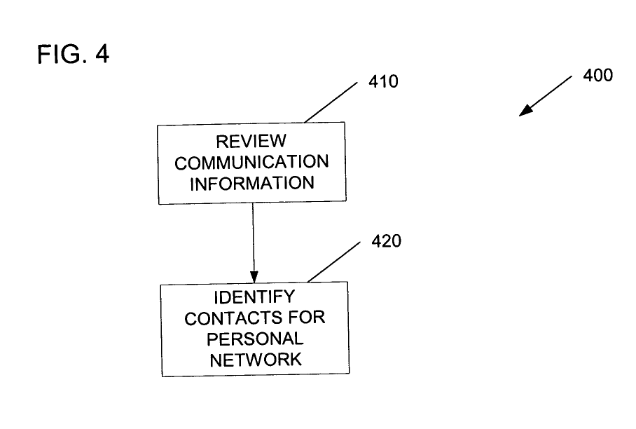

Referring now to FIG. 4, an example method 400 for recommending a personal network to a user is shown. Method 400 begins with review of the user's communication information. As noted above, the communication information can be obtained from a variety of sources such as, for example, electronic mail, instant messaging contacts, meetings, and distribution lists.

Next, control is passed to operation 420, where one or more contacts in the communication information are identified for inclusion in the user's personal network. One of a variety of methods described below can be used to identify which of the contacts from the communication information to recommend for inclusion in a user's personal network.

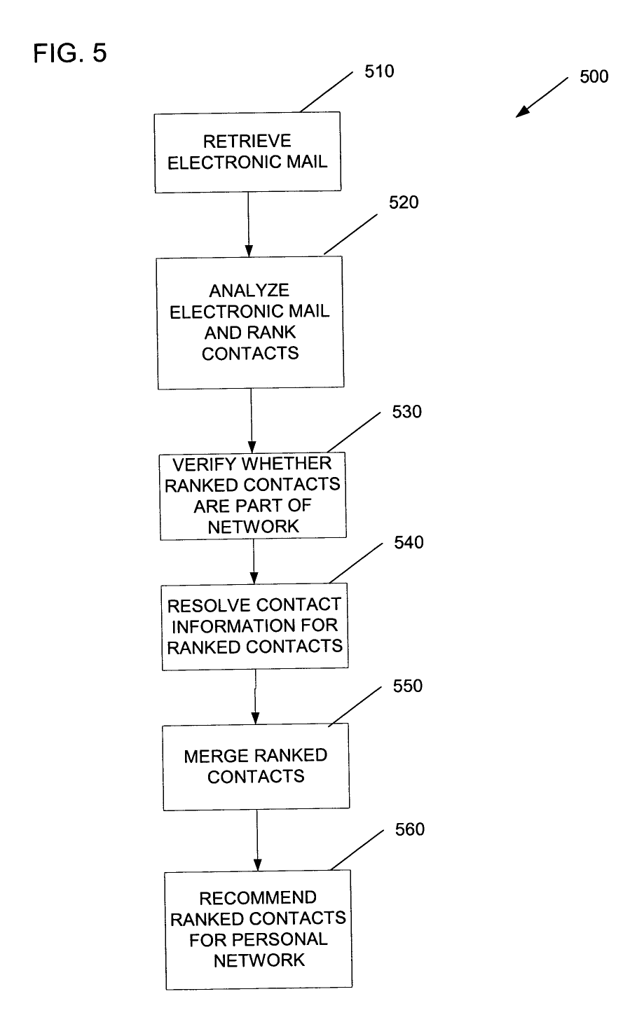

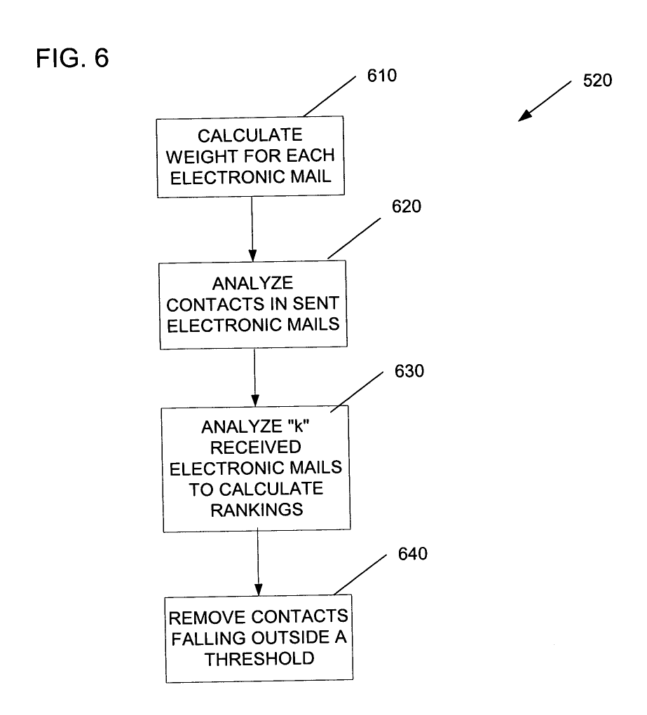

Referring now to FIG. 5, another example method 500 is illustrated for recommending a personal network using electronic mail as the communication information. In operation 510, the electronic mail is retrieved. Next, in operation 520, the electronic mail is analyzed. Generally, each of at least a set of electronic mail is analyzed (i) to establish a weight for the electronic mail in terms of its importance, and (ii) to identify the contacts associated with the electronic mail. The weight of each electronic mail is then used to rank the contacts identified in the electronic mail. Example methods for analyzing electronic mail and ranking the contacts identified therein are described below and illustrated in FIG. 6.

Once the contacts have been identified and ranked, control is passed to operation 530, and each ranked contact is verified to determine whether the contact has a profile in the organization's contact directory. In the illustrated embodiment, contacts in the user's personal network are limited to those contacts that are part of the user's organization. For example, in the systems 200 and 300 shown in FIGS. 2 and 3, the servers 240 and 240a can be queried to verify that each ranked contact has a profile on the server. In the illustrated example, if a contact does not have a profile, the contact is removed from the list of ranked contacts.

After the contacts are verified, control is passed to operation 540, where the complete address for each ranked contact is resolved. For example, some electronic mail programs store a proxy address or alias (e.g., “/company name/user login”) rather than a contact's complete address (e.g., “contact@microsoft.com”). To resolve a contact's complete address, server 240 in system 200 is queried to resolve any proxy addresses into complete addresses. In alternative embodiments, the proxy address can be parsed and resolved into the complete address without requiring querying of another server such as server 240.

Next, control is passed to operation 550, where ranked contacts from other sources are merged into a single ranked listed. For example, although the example shown in FIG. 5 includes only electronic mail as the communications information, if other types of communication information are analyzed (e.g., instant messaging contacts, meetings, and distribution lists), the results of the analysis of each type of communication information are merged into a single ranked list of contacts.

In one embodiment, the results from the different types of communication information are merged by calculating a merged ranking for each contact using Equation 1 below.
Merged Rank of Contact=(<Email Weight>)(Email Ranking)+(<Meetings Weight>)(Meetings Ranking)+(<Distribution List Weight>)(Distribution List Ranking) (1)
Example methods for calculating weights and rankings used in Equation 1 are described below. As illustrated by Equation 1, the merged ranking for each contact is a sum of the weight and ranking calculated for each type of communication information.

Once the merged ranking has been calculated, control is passed to operation 560, and the ranked contacts are provided to the user in a list. In one example, the contacts are listed in order of rank. In other examples, the contacts can be listed in other orders such as, for example alphanumeric order. The user can then select which contacts the user wants to include in the user's personal network.

Referring now to FIG. 6, the example method 520 for analyzing electronic mail and ranking the contacts identified therein is illustrated. At operation 610, a weight for a specified number of electronic mails is calculated. Each electronic mail is weighted to establish an importance for the electronic mail. For example, an electronic mail sent to the user as part of a large distribution list is weighted less than an electronic mail sent only to the user. It is therefore desirable to weigh the importance of each electronic mail and to use this weight in ranking the contacts identified in the electronic mail.

For example, in one embodiment, a significance function, G(n), is used to calculate a weight for each electronic mail. Equation 2 provided below is one example of a significance function, where “n” is the number of people to which an electronic mail was sent.

$$G ( n ) = \frac{1}{2} + \frac{1}{π} arctan ( 3 - 0.1 {n}^{1.2} ) \qquad ( 2 )$$

The significance function illustrated in Equation 2 will, for any given “n,” return a value between “0” and “1.” As the number of people “n” increases for a given electronic mail (i.e., as the number of people to which an electronic mail was sent increases), the result of the significance function rapidly approaches “0. ” For example, for electronic mails that have ten or more recipients, the result of the significance function approaches “0.”

Additional details regarding the significance function can be found in U.S. patent application Ser. No. 10/164,898 to Farnham et al., the entirety of which is hereby incorporated by reference.

The significance function therefore gives greater weight to electronic mails that are sent to a smaller number of people than those sent to a larger number of people. The significance function is configured in this manner because it is more likely that an electronic mail sent to a small number of individuals includes individuals that the user would consider as part of the user's personal network. Conversely, it is less likely that an electronic mail sent to a large number of individuals includes individuals that the user would consider as part of the user's personal network. For example, an electronic mail sent by the user to one person would be weighted higher than an email sent by the user to a general distribution list including thirty people.

The significance function illustrated as Equation 2 can be modified as necessary to adjust the weight given to electronic mails having a particular number of recipients. For example, increasing the exponent (currently set at 1.2) will increase the rate at which the weight of a given electronic mail decreases as the number of recipients of the electronic mail increases. Further, decreasing the constant (currently set at 3) will also cause the drop off in weight to occur sooner.

Further, the same significance function can be used to rank different types of communication information (e.g., electronic mail, instant messaging contacts, meetings, and distribution lists). However, the variables of the significance function can be modified so that different types of communication information have different drop-off rates. For example an electronic mail may not be significant if it has more than ten recipients, while a distribution list maybe significant for up to twenty people.

Referring again to FIG. 6, once a specified number of electronic mails have been weighted, control is passed to operations 620 and 630. In operations 620 and 630, the weight of each electronic mail is used along with other parameters associated with the electronic mail to rank the contacts identified in the electronic mail. For example, the following additional parameters are used in conjunction with the weight of each electronic mail to rank each contact identified in the electronic mail: the number of electronic mails sent to a specific contact; the number of electronic mails received by a specific contact; and the date of each electronic mail.

Specifically, at operation 620, the number of electronic mails sent by the user within a given date range to each contact are counted and stored as variable “k” for each contact. If a sent electronic mail has more than threshold number of recipients, then it is ignored. In the example embodiment, between 10 and 20 days of electronic mail is scanned, more preferably 15 days. In addition, a maximum number of sent electronic mails to scan are set at between 250 and 750, more preferably 500. Therefore, operation 620 will stop counting electronic mails when the date threshold or number threshold is reached.

In some embodiments, when calculating variable “k,” the number of electronic mails associated with each specific contact are truncated. For example, in one embodiment, the number of electronic mails received from a specific contact is truncated to equal the number of electronic mails sent to the specific contact so that a parity of received/sent electronic mails for each contact is reached. In another embodiment, the number of electronic mails sent to a specific contact is truncated to equal the number of electronic mails received from the specific contact so that a parity of sent/received electronic mails for each contact is reached. Electronic mails can be truncated based on, for example, the significance function score for each electronic mail (e.g., the lower-scored electronic mails are discarded).

Next, in operation 630, the electronic mails received by the user are analyzed. Specifically, the electronic mails received by the user are scanned to identify the weight for the first “k” electronic mails as calculated by the significance function. The significance function for each analyzed electronic mail involving a specific contact is summed to calculate a rank for the specific contact.
Contact Rank=ΣG(n) (2)
In the illustrated example, only a specified number of days as well as a total number of received electronic mails are scanned in an attempt to find the most recent “k” electronic mails for a given contact. In one embodiment, the number of days scanned is between 10 to 20 days, more preferably 15 days, and the maximum number of received electronic mails scanned is set at between 750 and 1250, more preferably 1000. The maximum number of received electronic mails scanned can be calculated based on various factors such as, for example, date, importance of electronic mail (e.g., priority), attachments, and read v. unread.

If the one of the recipients of an electronic mail is a distribution list, in the example embodiment illustrated, the distribution list is broken down and treated as if it were an electronic mail to its individual members. However, some electronic mails sent to large distribution lists are ignored because such distribution lists have insignificant rankings. In other embodiments, electronic mails can be ignored if the number of recipients exceeds a given threshold. In one embodiment, the maximum distribution size threshold is set to between 15 and 25, more preferably 20.

In the illustrated embodiment, once the ranking for each contact has been calculated, control is passed to operation 640, where the ranked list of contacts is truncated to a given number of contacts. For example, in one embodiment, the number of contacts in the ranked list is cut so that only the contacts with the top rankings are listed (e.g., the ranked list can be cut to between 50 and 100 of the top-ranked contacts). In other embodiments, the list can be truncated based on the magnitude of the rankings (e.g., contacts with a ranking below a threshold are cut).

In this manner, contacts for a user's personal network can be automatically identified and presented to the user without requiring the user to manually consider and generate a list of contacts. This allows for the efficient creation of a personal network and increases. In addition, because of the automated aspect of identification of the contacts, the likelihood that an individual will provide a meaningful personal network is increased.

In other embodiments, the following additional factors can be used when ranking contacts identified in electronic mail: the thread diversity (e.g., the greater the diversity of threads for a specific contact, the higher the rank for the specific contact); the frequency of electronic mail (e.g., the electronic mails sent during low frequency periods are weighted more highly than those sent during high frequency periods); the size of electronic mail (e.g., larger electronic mail is weighted more highly); the message content; the different address fields in an electronic mail (e.g., contacts listed in the “To” field are ranked higher than those listed in the “CC” field which, in turn, are ranked higher than those listed in the “BCC” field); and the latency between replies (e.g., a large latency between communications with a specific contact lowers the contact's rank).

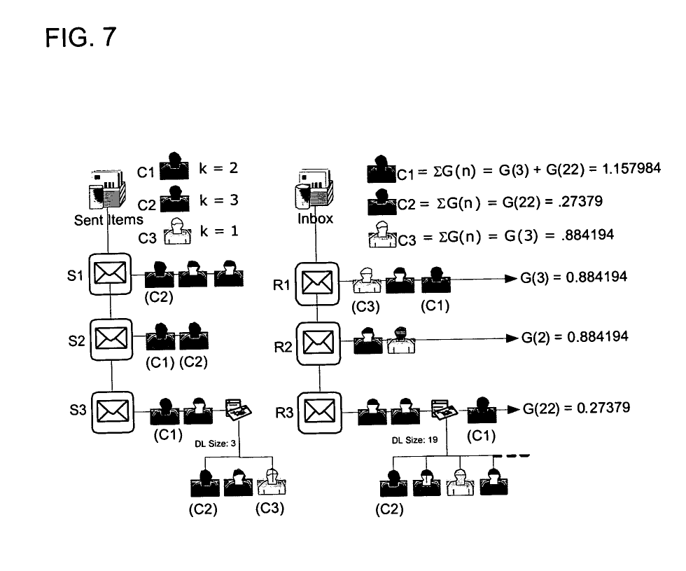

Referring now to FIG. 7, a simplified example representation of electronic mails for a user is provided. The user has three electronic mails S1, S2, and S3 that the user sent to various contacts, as well as three electronic mails R1, R2, and R3 that the user received from various contacts. To analyze the electronic mail, the significance function is used to calculate a weight for each of the received electronic mails (operation 610). For example, since electronic mail R1 includes three recipients, the significance function illustrated by Equation 2 above provides a weight of G(3)=0.884194 for electronic mail R1.

Next, the sent electronic mails are scanned to calculate the number of electronic mails sent to each contact (operation 620). For example, for contact C1, a value for “k” is set to “2” because the user has sent two electronic mails S2 and S3 to contact C1.

Next, each contact is ranked based on the weights calculated for the electronic mails R1, R2, and R3 sent by various contacts to the user (operation 630). For example, the rank for contact C1 is calculated to be 1.157984, or the sum of the weights for electronic mails R1 and R3 sent to contact C1. As identified at operation 560 of method 500, once the list of ranked contacts has been created, the list can be presented to the user to allow the user to select the user's personal network.

In some embodiments, the value for variable “k” is used as a threshold indicator regarding whether or not to recommend a specific contact. For example, in one embodiment only contacts with k>0 are considered for recommendation. In another embodiment, a specific contact is recommended if “k” is greater than a threshold even if the individual has not received any electronic mail from the specific contact. Other variations are possible.

Referring to FIG. 8, once the user has selected the user's personal network, the personal network can be added to the user's profile 800. For example, personal network 810 is listed in profile 800 for the user. This profile can be published to, for example, a server such as a Microsoft® SharePoint® Portal Server to allow others to access the user's personal network 810 on profile 800.

In the illustrated embodiment, the personal network 810 is broken into two groups and includes for each contact including contact name, position within the organization, and telephone number. Other contact information for each contact in the personal network (e.g., electronic mail address) can also be provided. In this manner, others can utilize the user's personal network 810 when attempting to identify specific contacts.

Another type of communication information that can be examined beyond a user's electronic mail is the meetings listed on the user's calendar such as, for example, a Microsoft® Outlook® Calendar. In the example illustrated, contacts associated with the user's meeting are ranked based on factors including: the number of individuals attending a given meeting; the date of the meeting; and the status of the meeting (i.e., whether the meeting was flagged as “Accepted,” “Tentative,” or “Rejected” by the user).

For example, the significance function provided by Equation 2 can be used to weight the meetings on a user's calendar for a specific date range. Once the weight for each meeting is calculated, the contacts in those meetings are ranked by summing the weights for each meeting associated with the contact using an equation similar to Equation 3 provided above.

The following pseudo code provides one example of how meetings can be analyzed:

```
foreach(Meeting in Outlook.Meetings) {
  if(Meeting.Status == “Accepted” && Meeting.Date > CurrentDate-
  DaysToScanMeetings) {
```

foreach(Recipient in Meeting.Recipients) {

```
if(SPServer.IsUser(Recipient)) {
  RecipientCount++;
} else if(SPServer.IsDistributionList(Recipient)) {
  If(SPServer. GetDistributionListSize(Recipient) <
  MEETINGS_MAXIMUM_DISTRIBUTION_LIST_SIZE)
  {
```

```
  RecipientCount +=
  SPServer.GetDistributionListSize(Recipient)
```

} else {

```
  Valid_Email=false;
  Break;
```

}
}

}

If(Valid_Email) {

foreach(Recipient in Meeting.Recipients) {

MeetingRankings[Recipient] +=
MeetingSignificance(ReceipientCount)
}

}

}
}

In the example pseudo code provided above, the maximum distribution size for a given meeting is set at between 25 and 35, more preferably 30 (i.e., meetings with more than the maximum number of participants are ignored). The number of days of meetings that are scanned is set at between 20 and 40, more preferably 30. Further, in one embodiment the exponent for the significance function is set at 1.05.

In other embodiments, additional attributes of meetings can also be examined when ranking contacts based on meetings. These attributes include: the duration of a meeting (e.g., a longer meeting would be given a higher weight); and the recurrence of a meeting.

Distribution lists can also be examined as part of the communication information for a user. A distribution list is, for example, a group of electronic mail addresses that is used so that electronic mail can be easily distributed to members of the group by referencing the distribution list. For example, distribution lists can be defined by the user in the user's Address Book in Microsoft® Outlook®. To calculate a ranking for each contact associated with a user's distribution lists, the following factors can be examined: the number of members; and mutual memberships.

Similar to electronic mails and meetings, rankings for contacts identified in distribution lists can be calculated by weighting each distribution list and then calculating a ranking for each contact based on the weightings. The following pseudo code illustrates one embodiment of how rankings for contacts identified in distribution lists can be calculated.

foreach(DistributionList in User.DistributionLists) {

if(DistributionList.size <
MAXIMUM_DISTRIBUTION_LIST_MEMBERS) {
foreach(Member in DistributionList.Members) {

DLRankings[Member]+=DLSignificance(DistributionList.size)

}
}

}

In the example pseudo code provided above, the maximum number of members for a distribution list is set at between 30 and 60, more preferably 50 (i.e., distribution lists with greater than this threshold number of members are ignored). In addition, in one embodiment, the exponent of the significance function is set at 0.95.

In other embodiments, additional attributes of distribution lists can also be examined when assigning rankings to contact identified in distribution lists. These attributes include: the name of the distribution list; and the sub-membership of a distribution list.

Another source of communication information is instant messaging contacts. Examples of instant messaging programs, which allow individuals to communicate in near real-time across networks, are Microsoft® MSN® Messenger and Windows® Messenger. The user's contact lists associated with these instant messaging programs can be analyzed to identify contacts to include as part of the user's personal network.

In some embodiments, it is necessary to automatically sign on to the instant messaging service, or have the user manually sign on to the instant messaging service, to retrieve the instant messaging contacts. In the example shown, all instant messaging contacts that are identified are recommended to the user for inclusion in the user's personal network because it is assumed that the user is relatively acquainted with each person with whom the user is instant messaging.

In some embodiments, group memberships can also be examined as part of the communication information for a user. For example, Microsoft® SharePoint® Portal Server allows users to be grouped into team site memberships. These group memberships can be examined using, for example, an algorithm similar to the significance function described above to identify contacts to recommend to the user for the user's personal network.

Various alternatives methods for combining rankings from different sources of communication information can be used (see Equation 1 above). For example, as noted above, in some embodiments every contact listed in an individual's instant messaging address book is recommended for inclusion in the individual's personal network. In alternative embodiments, the fact that a specific contact is included as an instant messaging contact can be used to alter the significance function used to analyze electronic mail (see Equation 2 above). For example, the significance function can be altered to provide a greater significance to each electronic mail associated with a contact that is part of the individual's instant messaging contacts.

In other embodiments, the rankings from each source of communication information are given different weights when merged. For example, in some embodiments, the rankings from instant messaging and appointment communication information are weighted more highly than rankings from electronic mail communication information. Other variations are possible.

In an alternative embodiment, the contacts are not only ranked but also grouped before being presented to the user for selection of the personal network. For example, to group contacts associated with received electronic mail, a matrix is built that counts the numbers of electronic mails sent/received front/to each user. Each row and column corresponds to contacts found in the header of an electronic mail (e.g., “To,” “From,” “CC,” and “BCC” fields).

The <i, j> entry of the matrix is incremented by I for every electronic mail where both contact i and contact j occur in the header. For electronic mails that are sent to a distribution list k and also have contacts i and j in the header, the <i, j> entry of the matrix is incremented by

$$\frac{1}{k + \text{(number of individual recipients)}} .$$

For example, if a distribution list has 98 members, then the <i, j> entry would be incremented by 1/100.

A similar matrix can be built for sent electronic mail. In addition to the matrix counting electronic mails sent by other users, an array is maintained where each index corresponds to a non-local contact. As electronic mails are being scanned, if the electronic mail was sent from the local user and the array entry corresponding to each recipient of that electronic mail is incremented by 1. Sent electronic mails are recorded in this array only and not in the matrix. Initially, each contact is placed into its own group in the array. If “Received Electronic Mail Cutoff Filtering” (see below) is enabled, then only contacts that pass through this filter are placed into the grouping array, and the rows and columns of contacts which have been filtered out are zeroed so those contacts will not be grouped with other people. If Grouping Cutoff Filtering is enabled, it is applied at this point as well.

Next, the matrix is analyzed over a series of iterations or until the matrix contains all zeroes. The matrix is then analyzed to find the maximum entry. The electronic mail addresses on the row and column of the maximum entry are considered to be paired together. For example if the maximum entry is found on <i, j>, then electronic mails i and j are considered to be paired together. The list of existing grouping is scanned and if there is already a group A that contains i but not j, then j is added to group A. If i already is a member of group A and j is a member of group B, then groups A and B are merged together. The <i, j> entry in the matrix is zeroed out and this cycle is repeated.

In some embodiments, different filters can be used to refine the groupings. For example, the number of iterations described above can be varied—more iterations will produce larger groups. In addition, “sent electronic mail filtering” can be used to exclude people whom the user receives mail on a frequent basis but does not write to (e.g., a contact that sends out company-wide electronic mails would be excluded from the groups).

In other embodiments, “Received Electronic Mail Cutoff Filtering” can be used to exclude grouping by people who do not appear in the headers of electronic mails where you are not the only recipient. This filter goes through the row in the matrix of the contact being analyzed and finds the maximum value. If the maximum value is less than a threshold, then this contact will not be used in the groupings and will not appear in the final results.

In other embodiments, “grouping cutoff filtering” can be used to reduce grouping of people who have electronic mail each other before but not enough to be grouped together. This filter will zero out any entries in the matrix that are less than a given threshold, therefore people who have not appeared in an electronic mail header together less the threshold will not be grouped together directly.

The various embodiments described above are provided by way of illustration only and should not be construed to limit the invention. For example, communication information from sources other than those listed above can also be used to identify contacts for a personal network. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. A computing system for automatically recommending a personal network, comprising:
a review module programmed to review communication information;
a recommend module in data communication with the review module, the recommend module being programmed to identify one or more contacts from the communication information and to recommend the contacts to a user for inclusion in a personal network; and
a builder module in data communication with the recommend module, the builder module being programmed to build the personal network based on specific contacts selected by the user from the contacts identified by the recommend module.

2. The system of claim 1, wherein the review module is programmed to review the communication information selected from a group consisting of electronic mail, contacts, meetings, group memberships, and distribution lists.

3. The system of claim 1, wherein the recommend module is programmed to use a significance function to rank the contacts.

4. The system of claim 1, wherein the recommend module is programmed to recommend a specific contact based on one or more criteria selected from a group consisting of number of electronic mails sent by the specific contact, size of distribution list for each electronic mail sent by the specific contact, and date of each electronic mail sent by the specific contact.

5. The system of claim 1, wherein the recommend module is programmed to recommend a specific contact based on one or more criteria selected from a group consisting of number of electronic mails sent to the specific contact, size of distribution list for each electronic mail sent to the specific contact, and date of each electronic mail sent to the specific contact.

6. The system of claim 1, wherein the recommend module is programmed to recommend a specific contact based on one or more criteria selected from a group consisting of number of attendees at a meeting with the specific contact, date of a meeting with the specific contact, and status of a meeting with a specific contact.

7. The system of claim 1, further comprising:
a verify module programmed to verify whether a specific contact is a member of a relevant group; and
a resolve module programmed to resolve contact information for the specific contact.

8. The system of claim 1, wherein the review module is programmed to review multiple types of communication information, and wherein the recommend module is programmed to recommend the contacts from the multiple types of communication information.

9. The system of claim 8, wherein the recommend module weights contacts in the multiple types of communication information based on in which type of communication information a specific contact is found.

10. The system of claim 1, wherein the review module is programmed to automatically review the communication information.

11. The system of claim 1, wherein the review module is programmed to periodically review the communication information.

12. A method for automatically recommending a personal network, comprising:
reviewing communication information stored on one or more computing systems;
identifying one or more contacts from the communication information to be included in a personal network;
displaying the contacts to a user; and
allowing the user to select specific contacts for inclusion in the personal network.

13. The method of claim 12, wherein the step of reviewing further comprises selecting communication information from a group consisting of electronic mail and meetings.

14. The method of claim 12, wherein the step of reviewing further comprises selecting communication information from a group consisting of electronic mail, contacts, meetings, group memberships, and distribution lists.

15. The method of claim 12, wherein the step of identifying further comprises ranking the contacts.

16. The method of claim 15, wherein the step of ranking further comprises using a significance function to rank the contacts.

17. The method of claim 15, wherein the step of ranking further comprises identifying a significance of each communication between the contacts and the user.

18. The method of claim 12, wherein the step of identifying further comprises:
reviewing electronic mail sent by a specific contact to the user; and
ranking the specific contact based on one or more criteria selected from a group consisting of number of electronic mails sent by the specific contact, size of distribution list for each electronic mail sent by the specific contact, and date of each electronic mail sent by the specific contact.

19. The method of claim 12, wherein the step of identifying further comprises:
reviewing electronic mail sent by a specific contact to the user; and
ranking the specific contact based on one or more criteria selected from a group consisting of number of electronic mails sent by the specific contact, size of distribution list for each electronic mail sent by the specific contact, date of each electronic mail sent by the specific contact, read status of each electronic sent by the specific contact, frequency of electronic mails sent by the specific contact; size of each electronic mail sent by the specific contact, message content of each electronic mails sent by the contact, and status of the user in each electronic mail sent by the specific contact.

20. The method of claim 12, wherein the step of identifying further comprises:
reviewing electronic mail sent by the user to a specific contact; and
ranking the specific contact based on one or more criteria selected from a group consisting of number of electronic mails sent to the specific contact, size of distribution list for each electronic mail sent to the specific contact, and date of each electronic mail sent to the specific contact.

21. The method of claim 12, wherein the step of identifying further comprises:
reviewing electronic mail sent by the user to a specific contact; and
ranking the specific contact based on one or more criteria selected from a group consisting of number of electronic mails sent to the specific contact, size of distribution list for each electronic mail sent to the specific contact, date of each electronic mail sent to the specific contact, frequency of electronic mails sent to the specific contact; size of each electronic mail sent to the specific contact, message content of each electronic mails sent to the contact, and status of the specific contact in each electronic mail sent by the specific contact.

22. The method of claim 12, wherein the step of identifying further comprises:
reviewing the user's meetings; and
ranking a specific contact included in one or more of the meetings based on one or more criteria selected from a group consisting of number of attendees at each meeting with the specific contact, date of each meeting with the specific contact, and status of each meeting with the specific contact.

23. The method of claim 12, wherein the step of identifying further comprises:
reviewing the user's meetings; and
ranking a specific contact included in one or more of the meetings based on one or more criteria selected from a group consisting of number of attendees at each meeting with the specific contact, date of each meeting with the specific contact, status of each meeting with the specific contact, duration of each meeting with the specific contact, and frequency of meetings with the specific contact.

24. The method of claim 12, wherein the step of identifying further comprises:
reviewing electronic mail sent by the user to a specific distribution list; and
ranking specific contacts in the specific distribution list based on one or more criteria selected from a group consisting of number of members of the specific distribution list and mutual membership between multiple distribution lists including the specific distribution list.

25. The method of claim 12, wherein the step of identifying further comprises:
reviewing electronic mail sent to a specific distribution list including the user; and
ranking specific contacts in the specific distribution list based on one or more criteria selected from a group consisting of number of members of the specific distribution list and mutual membership between multiple distribution lists including the specific distribution list.

26. The method of claim 12, wherein the step of identifying further comprises grouping the contacts into one or more groups.

27. The method of claim 26, wherein the step of grouping further comprises developing a matrix to group the contacts into the groups.

28. The method of claim 12, further comprising resolving contact information for the specific contacts.

29. The method of claim 12, further comprising verifying whether a specific contact of the contacts is a member of a relevant group.

30. The method of claim 29, wherein the step of verifying further comprises checking whether the specific contact has a profile for the relevant group.

31. The method of claim 12, wherein the step of reviewing further comprises reviewing multiple types of communication information.

32. The method of claim 31, wherein the step of identifying further comprises weighting contacts in the multiple types of communication information based on in which type of communication information a specific contact is found.

33. The method of claim 12, wherein the step of reviewing communication information is performed automatically.

34. The method of claim 12, wherein the step of reviewing communication information is performed periodically.

35. A computer program product readable by a computer and encoding instructions for executing the method recited in claim 12.

36. A method for building a personal network, comprising:
retrieving communication information;
identifying one or more contacts in the communication information;
verifying whether each contact is a member of a relevant group; and
recommending one or more of the contacts that are members of the relevant group to be included in a personal network.

37. The method of claim 36, wherein the step of verifying further comprises checking if each contact has a profile for the relevant group.

38. The method of claim 36, further comprising removing a specific contact from recommendation if the specific contact does not have a profile for the relevant group.

39. The method of claim 36, wherein the step of recommending further comprises displaying the recommended contacts.

40. The method of claim 36, wherein the step of retrieving further comprises selecting communication information from a group consisting of electronic mail, contacts, meetings, and distribution lists.

41. The method of claim 36, wherein the step of identifying further comprises using a significance function to rank the contacts.

42. The method of claim 36, wherein the step of recommending further comprises:
reviewing electronic mail sent by a specific contact to an individual; and
ranking the specific contact based on one or more criteria selected from a group consisting of number of electronic mails sent by the specific contact, size of distribution list for each electronic mail sent by the specific contact, and date of each electronic mail sent by the specific contact.

43. The method of claim 36, wherein the step of recommending further comprises:
reviewing electronic mail sent by an individual to a specific contact; and
ranking the specific contact based on one or more criteria selected from a group consisting of number of electronic mails sent to the specific contact, size of distribution list for each electronic mail sent to the specific contact, and date of each electronic mail sent to the specific contact.

44. The method of claim 36, wherein the step of recommending further comprises:
reviewing an individual's meetings; and
ranking a specific contact included in one or more of the meetings based on one or more criteria selected from a group consisting of number of attendees at each meeting with the specific contact, date of each meeting with the specific contact, and status of each meeting with the specific contact.

45. The method of claim 36, further comprising resolving contact information for a specific contact.

46. The method of claim 36, wherein the step of retrieving further comprises retrieving multiple types of communication information.

47. The method of claim 46, wherein the step of identifying further comprises weighting contacts in the multiple types of communication information based on in which type of communication information a specific contact is found.

48. The method of claim 36, wherein the step of retrieving communication information is performed automatically.

49. The method of claim 36, wherein the step of retrieving communication information is performed periodically.

50. A computer program product readable by a computer and encoding instructions for executing the method recited in claim 36.

51. A computer-readable medium having computer-executable instructions for performing steps comprising:
retrieving communication information;
identifying one or more contacts in the communication information;
verifying whether each contact is a member of a relevant group; and
recommending one or more of the contacts that are members of the relevant group to be included in a personal network.

52. The computer-readable medium of claim 51, wherein the step of verifying further comprises checking if each contact has a profile for the relevant group.

53. The computer-readable medium of claim 51, further comprising removing a specific contact from recommendation if the specific contact does not have a profile for the relevant group.

54. The computer-readable medium of claim 51, wherein the step of recommending further comprises displaying the recommended contacts.

55. The computer-readable medium of claim 51, wherein the step of retrieving further comprises selecting communication information from a group consisting of electronic mail, contacts, meetings, and distribution lists.

56. The computer-readable medium of claim 51, wherein the step of identifying further comprises using a significance function to rank the contacts.

57. The computer-readable medium of claim 51, wherein the step of recommending further comprises:
reviewing electronic mail sent by a specific contact to an individual; and
ranking the specific contact based on one or more criteria selected from a group consisting of number of electronic mails sent by the specific contact, size of distribution list for each electronic mail sent by the specific contact, and date of each electronic mail sent by the specific contact.

58. The computer-readable medium of claim 51, wherein the step of recommending further comprises:
reviewing electronic mail sent by an individual to a specific contact; and
ranking the specific contact based on one or more criteria selected from a group consisting of number of electronic mails sent to the specific contact, size of distribution list for each electronic mail sent to the specific contact, and date of each electronic mail sent to the specific contact.

59. The computer-readable medium of claim 51, wherein the step of recommending further comprises:
reviewing an individual's meetings; and
ranking a specific contact included in one or more of the meetings based on one or more criteria selected from a group consisting of number of attendees at each meeting with the specific contact, date of each meeting with the specific contact, and status of each meeting with the specific contact.

60. The computer-readable medium of claim 51, further comprising resolving contact information for a specific contact.

61. The computer-readable medium of claim 51, wherein the step of retrieving further comprises retrieving multiple types of communication information.

62. The computer-readable medium of claim 61, wherein the step of identifying further comprises weighting contacts in the multiple types of communication information based on in which type of communication information a specific contact is found.

63. The computer-readable medium of claim 51, wherein the step of retrieving communication information is performed automatically.

64. The computer-readable medium of claim 51, wherein the step of retrieving communication information is performed periodically.
